(19) United States
(12) Patent Application Publication
(10) Pub. No.: US 2006/0134183 A1
(43) Pub. Date: Jun. 22, 2006

(54) Pet food compositions having a defined relaxation property

(76) Inventors: Thomas Edward Huetter, West Chester, OH (US); Jeffrey Scott Lang, Venango, PA (US); Prasad Venkat Gopalkrishnan, Mason, OH (US); Lee P. Randall, Meadville, PA (US); Marko Stojanovic, Cincinnati, OH (US); Edward Russell Cox, Germantown, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/264,994

(22) Filed: Nov. 2, 2005

Related U.S. Application Data
(63) Continuation-in-part of application No. 11/175,581, filed on Jul. 6, 2005.
(60) Provisional application No. 60/600,938, filed on Aug. 12, 2004.

(51) Int. Cl. A23K 1/165

(52) U.S. Cl. 424/442; 426/635

(57) ABSTRACT

Disclosed herein are pet food compositions exhibiting a defined Maximum Relaxation Force and Maximum Relaxation Stress. The pet food compositions exhibit prolonged chew time by the pet. In optional embodiments, the pet food compositions comprise one or more of water, humectant, a grain source, or a cross-linking agent.

### CROSS REFERENCE TO RELATED APPLICATION

This application is a continuation-in-part of U.S. application Ser. No. 11/175,581, filed Jul. 6, 2005 and U.S. Provisional Application Ser. No. 60/600,938, filed Aug. 12, 2004.

### FIELD OF THE INVENTION

The present invention is directed to pet food compositions having a defined property which is believed to correlate with the length of time necessary for a pet to chew the composition. Additionally, through enhancement of the defined property of a pet food composition improved oral health can be achieved as a result of the mechanical chewing properties.

### BACKGROUND OF THE INVENTION

Known pet food compositions are available in a variety of forms and textures. Most of these pet food compositions tend to be inflexible, such as extruded pet food kibbles which are efficiently chewed and consumed by the pet. Depending upon the intended use or function of the composition, inflexibility may be a property which is desirable or undesirable. For example, kibbles provide the desirable advantage of enabling a pet to easily consume a nutritionally balanced food, such as to provide the nutrients necessary to sustain life. As another example, crunchy treats, also easily consumed, are efficient forms useful to responsively reward positive behavior.

It is advantageous, however, to provide pet food compositions which are less efficiently chewed by the pet. These compositions may be useful for a variety of purposes. For example, prolonged chewing action may result in advantageous mechanical cleaning of the teeth through consistent and prolonged contact with the teeth or extended release of any therapeutic actives. Additionally or alternatively, behavioral issues such as continuous chewing of inappropriate objects may be ameliorated through prolonged enjoyment (through chewing) of the composition.

Unfortunately, known chews tend to be consumed by a pet more quickly than would be desirable to achieve the above stated purposes or, alternatively or additionally, known chews are hard or brittle. Still further, other known chews contain significant levels of rawhide, or are wholly made of rawhide, which is undesirable for a pet in view of issues associated with compromised digestibility of the rawhide (which can result in vomiting by the pet).

One of the most common health problems in companion animals is dental disease. The primary mechanism responsible for creating this condition is the accumulation of plaque on the tooth surface. Plaque is formed when glycoproteins and bacteria adhere to the teeth. At the onset of this process, the biofilm is quite soft and composed of a random organization of bacteria, food particles, sloughed epithelial cells and salivary mucin. Typical pet foods do not provide sufficient mechanical cleansing properties during a short mastication period to efficiently remove plaque. If left undisturbed, the plaque colony will continue to mature and the bacteria will stratify and adhere more tightly to the tooth surface. It is this accumulation of anaerobic bacteria along the gumline that leads to inflammation of the soft tissue and gingivitis. Further, once established, the next evolution of the biofilm involves the precipitation of salivary mineral components (dental calculus) as well as stain. Once hardened, the calculus remains closely adhered to the tooth surface both above (supragingival) and below (subgingival) the gumline. The porous surface of the deposit then serves as a nidus for new biofilm plaque and more stain deposition. The end result is a continuing cycle of plaque deposition followed by inflammation and mineralization.

The present inventors have discovered pet food compositions that exhibit properties which, without being limited by theory, are believed to correlate with the length of time necessary for a pet to chew the composition, while still exhibiting a flexibility not exhibited by hard or brittle compositions. In view of this discovery, the inventors are now able to provide pet food compositions that may achieve the purposes set forth above, thereby optionally providing certain benefits such as mechanical cleaning of the teeth, extended release of any therapeutic actives, or amelioration of behavioral issues in addition to reduction of plaque, tartar, stain, and gingivitis. These and other benefits of the present invention are described herein.

### SUMMARY OF THE INVENTION

Disclosed herein are pet food compositions exhibiting a defined Maximum Relaxation Stress and a Maximum Relaxation Force. In particular, the pet food compositions exhibit a Maximum Relaxation Stress of at least about 2.5 MPa. In particular, the pet food compositions exhibit a Maximum Relaxation Force of at least about 1 kN. The pet food compositions exhibit prolonged chew time by the pet.

### BRIEF DESCRIPTION OF THE FIGURES

FIG. 1 indicates a plot of force (in kN) versus time (in seconds) for three illustrative, pet food compositions of different dimensions, small, medium and large, tested in accordance with the Maximum Relaxation Force methodology described herein.

FIG. 2 indicates pet food compositions contrast brought out in terms of geometry-independent stress measurements i.e. Maximum Relaxation Stress (MPa) so as to be able to compare pet food compositions of different dimensions, small, medium and large.

### DETAILED DESCRIPTION OF THE INVENTION

Various documents including, for example, publications and patents, may be recited throughout this disclosure. All such documents are hereby incorporated by reference. The citation of any given document is not to be construed as an admission that it is prior art with respect to the present invention.

All percentages and ratios are calculated by weight unless otherwise indicated. All percentages and ratios are calculated based on the total composition unless otherwise indicated.

The compositions herein may comprise, consist essentially of, or consist of any of the features or embodiments as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As used herein, the term “pet” means a domestic animal preferably including (for example) a dog, cat, horse, cow, pig, rabbit, and the like. Domestic dogs and cats, particularly dogs, are particularly preferred pets.

### The Compositions of the Present Invention

The pet food compositions described herein may be useful for a variety of purposes. It is believed that prolonged chew time is particularly advantageous for a variety of reasons including, for example, enhanced contact with the teeth, thereby providing the opportunity for advantageous mechanical cleaning of the teeth (particularly wherein brushing or other preventative measures are not desirable or practical), extended release of any therapeutic actives, or prolonged enjoyment of the composition (which may lead to general well-being of the pet or distraction from disruptive behaviors such as chewing household articles not intended for such chewing) or reduction of plaque, tartar, stain, and gingivitis.

Without intending to be limited by theory, it is believed that prolongation of chew time by the pet correlates with a particular property of the composition, related to springiness or resilience of the composition, which for convenience herein is described as the ‘relaxation’ of the composition. It is therefore believed that such relaxation may be characterized as one factor which represents ‘chewiness’ of a composition. Again without limitation by theory, it is the enhanced relaxation strength of the pet food composition, as defined herein by the Maximum Relaxation Force and/or Maximum Relaxation Stress, which is believed to correlate with a prolonged chew time of the composition when consumed by the pet. Based on this believed correlation, the inventors herein have characterized the present compositions in relation to the relaxation force characteristic, defined herein for convenience as the Maximum Relaxation Force exhibited by the compositions.

It is found that, by virtue of the Maximum Relaxation Force defined herein, a single serving of the pet food compositions herein (for example, having a mass of from about 15 grams to about 70 grams) may optionally be consumed by the pet over a period of at least about 5 minutes, or at least about 10 minutes, or at least about 20 minutes, or at least about 30 minutes. Pets of relatively small size, such as small breed dogs, may tend to consume the pet food composition over a longer period of time relative to those of relatively larger size.

The pet food compositions exhibit a Maximum Relaxation Force of at least about 1 kN, preferably at least about 1.5 kN, more preferably at least about 1.8 kN, still even more preferably at least about 2 kN, still even more preferably at least about 2.5 kN.

The pet food compositions exhibit a Maximum Relaxation Stress of at least about 2.5 MPa, preferably at least about 2.8 MPa, more preferably at least about 3 MPa, even more preferably at least about 3.5 MPa.

The pet food compositions herein are adapted for use by a pet. In this respect, as will be well understood by the ordinarily skilled artisan, the primary use of the compositions described herein is for use by a pet and the compositions are therefore formulated for such use. As used herein, the term “pet food composition” means a composition that is intended for ingestion by a pet. These will advantageously include foods intended to supply necessary dietary requirements (such as nutritionally balanced foods (those composition having known required nutrients to sustain life in proper amounts and proportion based on recommendations of recognized authorities in the field of pet nutrition)), as well as supplements, as used herein means treats and/or chews. As one of ordinary skill will recognize in view of this disclosure, the pet food compositions are advantageously chews for pets such as dogs, wherein the prolonged chew time imparted by the composition as exhibited by the Maximum Relaxation Force (as described more fully herein below) and the Maximum Relaxation Stress (as described more fully herein below) provides advantageous mechanical cleaning of the teeth, extended release of any therapeutic actives, prolonged enjoyment of the composition, or the like.

Non-limiting examples of these pet food compositions are those which may be classified as chews in the pet food industry, intended for prolonged chewing by the pet. Chews can be provided in a variety of forms, including those prepared by baking, extrusion, injection molding, transfer molding, and/or compression molding. Chewing action allows the pet to softly penetrate the chewable composition, promoting for example, clean, healthy teeth and/or fresh breath.

The pet food compositions may comprise any of a variety of components, provided that the compositions exhibit the defined Maximum Relaxation Force and/or Maximum Relaxation Stress. Without intending to be limited by theory, it is believed that compositions exhibiting such Maximum Relaxation Force and/ or Maximum Relaxation Stress may optionally comprise water, humectant, a legume source, a grain source, or a cross-linking agent and, as such, the pet food compositions herein optionally comprise at least one of such components or such other components providing compositions exhibiting the defined Maximum Relaxation Force and/or Maximum Relaxation Stress. These and other optional components of the present pet food compositions are described as follows:

In an embodiment useful for oral health, the pet food composition provides improvements via mechanical removal of plaque accumulation. One of the most common health problems in companion animals is dental disease. The pet food composition targets plaque removal through extended chewing and contact time with the pet food composition. A means of improving oral health can be achieved that can extend benefits that will help control plaque, calculus, stain, and gingival inflammation.

In an optional embodiment herein, the pet food composition comprises at least one humectant. Without intending to be limited by theory, it is believed that the presence of one or more humectants contributes to the ability of the composition to retain water (moisture), which further contributes to the relaxation of the compositions, and therefore believed correlation with chew time. Humectants are widely known in the art, such as those selected from polyhydric alcohols (e.g., glycerol (also often referenced as glycerin), propylene glycol, glycerol diglycerol, propylene glycol, triethylene glycol, polyvinyl alcohol, polyethylene glycol, sorbitol, mannitol, maltitol, and the like), fatty acid esters (e.g., glyceryl monostearate), sugars (e.g., corn syrups, sucrose, and the like), and mixtures thereof. In one embodiment herein, the composition comprises at least one of such humectants, or at least two of such humectants. Humectants which may be particularly advantageous include polyhydric alcohols (e.g., glycerol) and sugars (e.g., corn syrup, such as high fructose corn syrup).

In an embodiment herein, the compositions may comprise at least about 1% of humectant, or at least about 10%, or at least about 15%, or at least about 20%, or at least about 25% of humectant, all optionally up to levels of about 35% or 50% of humectant, all by weight of the composition. Such levels of humectant reference the total of all humectants present in the composition.

In one embodiment herein, the pet food composition comprises water. Without intending to be limited by theory, it is believed that the presence of water at relatively elevated levels may be a factor contributing to the unique properties of the pet food compositions, in particular its ability to exhibit the relaxation properties described herein.

In an optional embodiment herein, the compositions may comprise at least about 5% water, or at least about 10%, or at least about 14%, or at least about 15%, or at least about 18%, or at least about 20% water, all optionally up to levels of about 25% or 30% water, all by weight of the composition.

In an embodiment herein, the pet food compositions can exhibit a water activity (A_{w}) of at least about 0.5, preferably at least about 0.6, preferably about 0.75, preferably about 0.8 water activity. Water activity is measured in accordance with techniques which are quite standard in the art. Wherein the pet food composition comprises relatively high levels of water, it may be desirable to include one or more mold inhibitors, such as potassium sorbate, calcium propionate, or the like.

Other components optionally beneficial for inclusion in the compositions used herein include a source of protein, carbohydrate, and/or fat, preferably at least protein and carbohydrate.

Crude protein material may comprise vegetable proteins such as soybean, cottonseed, and peanut, or animal proteins such as casein, albumin, and meat protein. Non-limiting examples of meat protein useful herein include a protein source selected from the group consisting of beef, pork, lamb, poultry, fish, vegetable, and mixtures thereof. The compositions may also contain other materials such as dried whey and other dairy by products.

Carbohydrate may be advantageously sourced through inclusion of a grain or a legume source. Without intending to be limited by theory, it is believed that the presence of such a grain may be a factor contributing to the unique properties of the pet food compositions, in particular its ability to exhibit the relaxation properties described herein. In one embodiment herein, the pet food composition comprises at least one grain source. Grain sources are widely known in the art, such as those selected from corn, oats, rice, milo, sorghum, barley, wheat, and mixtures thereof. In one embodiment herein, the composition may comprise at least one grain source, or at least two grain sources, or at least three grain sources.

Wheat may be advantageously utilized. Sources of wheat may include, for example, whole wheat, wheat flour, wheat gluten, wheat bran, wheat farina, wheat malt, wheat starch, and mixtures thereof, and the like. Wheat flour and wheat gluten, and mixtures thereof, may be particularly advantageous sources of wheat.

Legume sources are widely known in the art, such as soy.

In an embodiment herein, the pet food compositions may comprise one or more cross-linking agents. Without intending to be limited by theory, it is believed that such cross-linking agent may contribute to the three-dimensional structure of the pet food composition, thereby contributing to the Maximum Relaxation Force and/or Maximum Relaxation Stress exhibited by such composition. Cross-linking agents are widely known in the art, for example, sulfur, DL-methionine, and sodium metabisulfite.

In an embodiment herein, the pet food compositions have a relatively low fat content, particularly for similar reasons related to desirability of relatively low caloric load. Fat content may be advantageously manipulated through, for example, increasing the carbohydrate and/or protein levels relative to the fat levels. For example, optionally, the pet food compositions may be substantially free of fat, meaning comprising less than about 4% fat, by weight of the composition. In other embodiments, the pet food compositions may comprise less than about 3%, or less than about 2% fat, by weight of the composition.

In an embodiment herein, the pet food compositions have a relatively low caloric load. This may be particularly advantageous wherein the compositions are food supplements, as caloric load in addition to that provided through a complete and balanced food may be undesirable for the pet, particularly depending on the quantity of composition supplied to the pet on a daily, or other defined, basis. For example, optionally, the pet food compositions may have a caloric load of less than about 10 calories per gram of composition, or less than about 5 calories per gram of composition.

In an embodiment herein, the pet food composition comprises one or more therapeutic actives. For example, the pet food compositions may possess the ability to sequester calcium, inhibit bacterial growth, inhibit plaque, inhibit tartar (defined herein as including calculus), improve malodor of the oral cavity, or the like. The pet food compositions may be further advantageous for the inhibition of periodontal disease, gingivitis, breath odor, and the like.

In an embodiment useful for oral health, the pet food compositions may optionally comprise a soluble mineral component. As used herein, the term “soluble” with respect to the mineral component means that at least about 50% of the mineral component, by weight of the mineral component, dissolves in a sample of water (in an amount typically present during mastication) at ambient temperature. Optionally, the term “soluble” with respect to the mineral component means that at least about 75%, or at least about 90%, of the mineral component, again by weight of the mineral component dissolves in this sample of water (in an amount typically present during mastication) at 25° C. The soluble mineral component may be provided wherein at least a portion of the phosphate component is coated on the surface of the composition, integrated within the composition, or both.

The composition may comprise an amount of the soluble mineral component which is an effective amount for use as an oral medicament, as has been defined herein above. As an example, the composition may optionally comprise at least about 0.01%, or at least about 0.02%, or at least about 0.05%, or at least about 0. 1%, or at least about 0. 15% of the mineral component, by weight of the composition. As a further example, the composition may optionally comprise from about 0.01% to about 10%, or from about 0.02% to about 5%, or from about 0.05% to about 5%, or from about 0.1% to about 2%, or from about 0.15% to about 1%, of the mineral component, by weight of the composition. Specific illustrative amounts of each mineral which may optionally be utilized in the mineral component are described below.

The soluble mineral component may optionally comprise one or more minerals selected from zinc, manganese, tin, copper, and mixtures thereof. Various embodiments described herein may, for example, comprise two or more, or three, or all four of these minerals. Moreover, the minerals from which selections may be drawn may be modified, for example wherein the minerals are selected from manganese, tin, copper, and mixtures thereof. Illustrative minerals, including exemplary sources and amounts, are described as follows:

The soluble mineral component may optionally comprise zinc. Sources of zinc which will contribute to a soluble mineral component will be well-known to those of ordinary skill in the art. Illustrative sources of zinc include zinc sulfate, zinc gluconate, zinc chloride, zinc citrate, zinc lactate, zinc malate, zinc tartrate, and mixtures thereof. Zinc sulfate monohydrate may be a particularly useful zinc source. Zinc citrate may impart enhanced palatability relative to certain other zinc sources due to chelation with the citrate. Wherein the composition comprises zinc, the composition may optionally comprise at least about 0.001% zinc ion, at least about 0.01% zinc ion, at least about 0.05% zinc ion, or at least about 0.07% zinc ion, or at least about 0.1% zinc ion, by weight of the composition. As a further example, wherein the composition comprises zinc, the composition may optionally comprise from about 0.001% to about 1%, or from about 0.005% to about 0.75%, or from about 0.05% to about 0.5%, or from about 0.1% to about 0.4% zinc ion, all by weight of the composition.

The soluble mineral component may optionally comprise tin. Sources of tin which will contribute to a soluble mineral component will be well-known to those of ordinary skill in the art. Illustrative sources of tin include tin lactate, tin gluconate, tin acetate, tin sulfate, tin malate, and mixtures thereof. Wherein the composition comprises tin, the composition may optionally comprise at least about 0.0001% tin ion, at least about 0.0005% tin ion, or at least about 0.001% tin ion, or at least about 0.0015% tin ion, by weight of the composition. As a further example, wherein the composition comprises tin, the composition may optionally comprise from about 0.0001% to about 0.5%, or from about 0.0005% to about 0.1%, or from about 0.001% to about 0.05%, or from about 0.001% to about 0.25% tin ion, all by weight of the composition.

The soluble mineral component may optionally comprise copper. Sources of copper which will contribute to a soluble mineral component will be well-known to those of ordinary skill in the art. Illustrative sources of copper include copper chloride, copper gluconate, copper sulfate, copper bisglycinate, copper lactate, copper malate, copper acetate, copper citrate, copper tartrate, and mixtures thereof. Copper gluconate is particularly preferred herein. Wherein the composition comprises copper, the composition may optionally comprise at least about 0.0005%, or at least about 0.01%, or at least about 0.015%, or at least about 0.02% copper ion, all by weight of the composition. As a further example, wherein the composition comprises copper, the composition may optionally comprise from about 0.0005% to about 0.5%, or from about 0.0005% to about 0.1%, or from about 0.01% to about 0.1%, or from about 0.015% to about 0.05%, or from about 0.02% to about 0.25% copper ion, all by weight of the composition.

The soluble mineral component may optionally comprise manganese. Sources of manganese which will contribute to a soluble mineral component will be well-known to those of ordinary skill in the art. Illustrative sources of manganese include manganese chloride, manganese sulfate, manganese gluconate, manganese acetate, manganese malate, manganese tartrate, manganese citrate, manganese lactate, manganese glycinate, and mixtures thereof. Manganese sulfate monohydrate may be particularly useful. Wherein the composition comprises manganese, the composition may optionally comprise at least about 0.0001% manganese ion, or at least about 0.001%, or at least about 0.01%, or at least about 0.015%, or at least about 0.02% manganese ion, by weight of the composition. As a further example, wherein the composition comprises manganese, the composition may optionally comprise from about 0.0001% to about 1%, or from about 0.001% to about 0.5%, or from about 0.01% to about 0.5%, or from about 0.05% to about 0.4% manganese ion, all by weight of the composition.

In an optional embodiment herein, wherein a mineral component is used, at least a portion of the mineral component is coated on the surface of the composition. Consistent with this embodiment, the mineral component can be provided on the surface of the composition without substantial compromise in the organoleptic, or other key properties of the composition. As such, the compositions may be satisfactorily administered to the pet while providing optimized efficacy since the mineral component is readily available and quickly solubilized in the oral cavity of the pet. In a further optional embodiment, at least about 50% of the mineral component, or at least about 75% of the mineral component, or at least about 90% of the mineral component, or at least about 95% of the mineral component, all by weight of the mineral component, is coated on the surface of the composition.

In another embodiment herein, at least a portion of the mineral component is integrated within the edible composition. This is particularly desirable in the context of this invention wherein the pet chews the composition over an extended period of time. The inventors have discovered that, in this embodiment, efficacy is enhanced through availability of the mineral component over an extended period of time.

In another embodiment herein, the compositions may comprise a mineral component and a phosphate component. This phosphate component is not limited to the chain length of phosphate utilized; rather, the benefits of the phosphate component may be enhanced when combined with mineral component, regardless of chain length. The composition may optionally comprise an amount of a phosphate component which is an effective amount for use as an oral medicament, as has been defined herein above. Optionally, unlike the complexes described in U.S. Pat. No. 5,000,944, the mineral component and the phosphate component, or any individual components thereof, are not present as a complex in the composition.

The phosphate component may comprise a component which contains at least 2 phosphorous atoms. Illustrative compounds which may be utilized as the phosphate component include pyrophosphates, polyphosphates, or mixtures thereof. Kirk & Othmer, Encyclopedia of Chemical Technology, 2^{nd} Ed., Vol. 15 (1965), pp. 232 to 276, discloses a number of water-soluble inorganic pyrophosphate salts.

In another embodiment herein, at least a portion of the phosphate component is a pyrophosphate. For example, inorganic pyrophosphates such as alkali metal pyrophosphates including sodium acid pyrophosphate (SAPP) and tetrapotassium pyrophosphate (TKPP) may be utilized. Illustrative examples of SAPP include SAPP having a molecular weight of about 222. Also useful may be a tetraalkali metal pyrophosphate such as tetralithium pyrophosphate. Examples of dialkaline metal pyrophosphates are dicalcium pyrophosphate, dibarium pyrophosphate, and dimagnesium pyrophosphate. Trialkali metal monoacid pyrophosphates such as trisodium hydrogen pyrophosphate may also be used.

In another embodiment, at least a portion of the phosphate component is a polyphosphate. As will be readily understood in the art, as the chain length of the polyphosphate increases, the polyphosphate is provided as multiple length species having an average chain length. Polyphosphates may also be utilized herein, such as those polyphosphates having an average chain length of 3 or greater. Examples include tripolyphosphates such as sodium tripolyphosphate (STPP), SODAPHOS (average chain length of 7), HEXAPHOS (average chain length of 13) (commercially available from FMC Corporation), other hexametaphosphate (such as, average chain length of 21), and sodium acid metaphosphate. Illustrative examples of hexametaphosphate include sodium hexametaphosphate or potassium hexametaphosphate having a molecular weight of about 2200.

The phosphate component may optionally be provided wherein at least a portion of the phosphate component is coated on the surface of the composition, at least a portion of the phosphate component is integrated within the composition, or both.

Further embodiments include those pet food compositions (for example, chews) wherein at least a portion of the mineral component is coated on the surface of the composition and at least a portion of the phosphate component is integrated within the composition, or at least a portion of the phosphate component is coated on the surface of the composition and at least a portion of the mineral component is integrated within the composition, or wherein at least a portion of both the mineral and phosphate components are coated on the surface of the composition, or wherein at least a portion of both the mineral and phosphate components are integrated within the composition.

As an example, the composition may optionally comprise at least about 0.05%, or at least about 0.1%, or at least about 0.2%, or at least about 0.5%, or at least about 1% of the phosphate component, by weight of the composition. As a further example, the composition may optionally comprise from about 0.05% to about 10%, or from about 0.1% to about 5%, from about 0.2% to about 4%, or from about 0.5% to about 4% of the phosphate component, by weight of the composition.

In yet another embodiment, the present pet food compositions may comprise one or more fermentable fibers. The fermentable fiber may be any fiber source which intestinal bacteria present in the pet can ferment to produce short chain fatty acids or other metabolic components. Non-limiting examples of such fermentable fibers include inulin, chicory, beet pulp (from sugar beet), gum arabic, gum talha, psyllium, rice bran, carob bean gum, citrus pulp, pectin, fructooligosaccharides, galactooligosaccharide, oligofructoses, mannanoligosaccharides, soy fiber, arabinogalactan, arabinoxylan, and mixtures thereof.

As an example, the pet food composition may optionally comprise at least about 0.001%, or at least about 0.01%, or at least about 0.1%, or at least about 0.5%, or at least about 1%, or at least about 2% of total fermentable fiber, all optionally up to levels of about 10%, 25%, or 50% fermentable fiber, all by weight of the composition.

In another embodiment herein, the pet food compositions are substantially free of rawhide. The term “substantially free of rawhide” means that the referenced composition comprises less than about 1% rawhide, preferably less than about 0.5%, and most preferably less than about 0.2% rawhide, all by weight of the composition.

In another embodiment herein, the pet food compositions are substantially free of synthetic polymer. The term “substantially free of synthetic polymer” means that the referenced composition comprises less than about 1% synthetic polymer, preferably less than about 0.5%, and most preferably less than about 0.2% synthetic polymer, all by weight of the composition. Non-limiting examples of synthetic polymer include polyurethane, rubber, or nylon.

Methods

Maximun Relaxation Force Method/Maximun Relaxation Stress Calculation

The Maximum Relaxation Force is determined in accordance with the following methodology:

An INSTRON® Model 4502 is used for this method (herein referred to as the “INSTRON”, commercially available from Instron Corporation, Canton, Mass., U.S.A.). The INSTRON is run in dynamic compression mode with a 10 kN load cell for force measurement. The upper platen moves, and the lower platen is stationary. The test samples chosen for the characterization are, if necessary, cut across the cross-section to form samples of 1 inch length each.

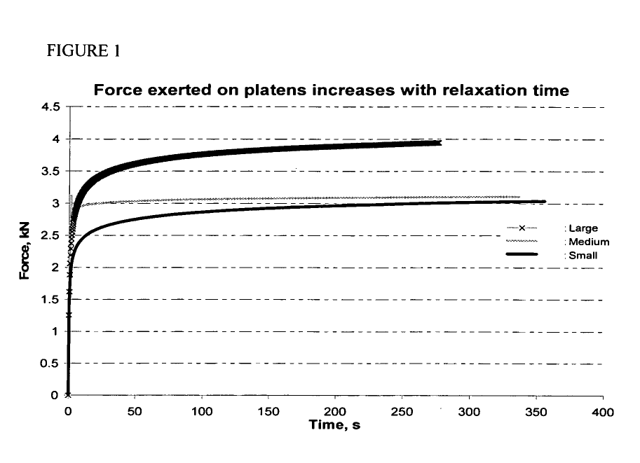

Relaxation measurements of a pet food compositions are conducted at a temperature of 25° C. and a relative humidity of 30%, measured in accordance with techniques which will be quite well-known to those of ordinary skill. The INSTRON is utilized for these measurements. The INSTRON controller is turned on. The controller communicates with a personal computing device for data acquisition via the Series IX software interface also available from the INSTRON Corporation. In ‘Method’ creation using Series IX, the personal computing device is set up for data acquisition to be initiated by the INSTRON controller input and to stop by computer input within Series IX. This enables repeated cycling as desired for chewing simulation. The INSTRON is calibrated prior to load measurement. To do this, the appropriate load cell is attached to the INSTRON. The load cell has to be chosen in accordance with the expected data ranges. Based on this, the 10 kN load cell is chosen as appropriate for the data ranges of interest. The pet food composition is placed on the lower platen, and the upper platen is adjusted such that the upper platen is in contact with the sample but exerts no measurable force. A constant cross-head velocity of 50 mm/min is used and set on the controller panel for accurate control over the position of the upper platen during testing. The diameter of the pet food composition at the start of the measurement is set as the maximum extension on the controller panel. To effectively simulate chewing, the test sample is compressed down to 80% of its original average width. This is set as the minimum extension limit. The upper platen is then actuated. This motion actuation also initiates the data procurement by Series IX software on the personal computing device. Increasing compression translates into increasing force readout, with a peak attained at 80% compression. Following maximum compression, the upper platen is cycled back by the controller at the same velocity to the initial position. A flexible pet food composition relaxes as is observed from the increasing force measured at the upper platen after stopping motion at the maximum extension. Each cycle is defined as one compression and a complete retraction stroke. The pet food compositions are cycled through two cycles and a final compression stroke prior to allowing relaxation. Each bite causes additional flattening of the pet food composition. At the end of the third compression stroke, the upper platen is stopped at the 80% compression limit. As the flexible sample relaxes and expands, it pushes against the upper platen which provides a force feedback to the load cell. The pet food composition is then allowed to relax for 15 minutes or an appropriate time of data collection. Depending on the extent of relaxation, different pet food compositions provide varying force response. Without intending to be limited by theory, the more ‘chewy’ pet food compositions cause a more significant increase in the reversal of compression over this relaxation period. A curve of force versus time is generated from this data, resulting in a measurable plateau. The force, in kN, at the plateau is the Maximum Relaxation Force exhibited by the test sample. FIG. 1 is illustrative of resulting curves and plateaus for pet food compositions of different dimensions, small, medium and large, of the present invention.

This force acts on the horizontal cross-section of the sample. Knowing the pet food composition dimensions (length=1 inch and diameter) enables calculation of the horizontal cross sectional area and the Maximum Relaxation Stress generated within the pet food composition per the Equation I that follows.
Maximum Relaxation Stress (MPa) =Force (kN)×1000/Area (mm²) Equation I:

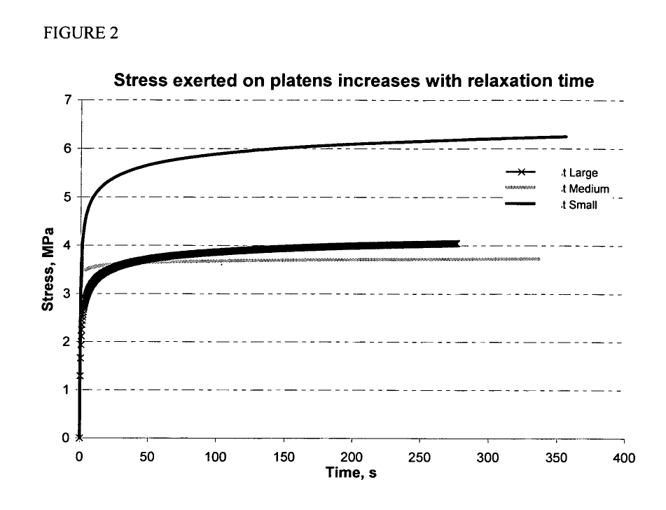

FIG. 2 is illustrative of pet food compositions contrast brought out in terms of geometry-independent stress measurements i.e. Maximum Relaxation Stress, so as to be able to compare samples of different dimensions, for example small, medium and large.

Methods of Making

The pet food compositions herein are made according to methods which will be well known by the ordinarily skilled artisan. To illustrate, the compositions of the present invention may be prepared by mixing or grinding all components singularly or in suitable combinations together, and in water where appropriate, agitating mechanically until all of the ingredients have been solubilized, dispersed, or otherwise mixed, as applicable. Wherein certain processes such as extrusion (to form chews, for example) or baking are utilized, such processes will be well-known in the art.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### EXAMPLES

The following are non-limiting examples of the present pet food compositions which may optionally be prepared utilizing conventional methods. The following examples are provided to illustrate the invention and are not intended to limit the scope thereof in any manner.

### Example 1

The pet food composition is a chew product adapted for use by a domestic dog and can be prepared using the following components at the indicated amounts:

| | Approximate Amount % |
|---|---|
| Component | (by weight of the composition) |
| Wheat Flour and Wheat Gluten | 53 |
| High Fructose Corn Syrup | 13 |
| Glycerin and Glyceryl Monostearate | 12 |
| Beet Pulp | 4 |
| Sodium Tripolyphosphate | 2 |
| Vegetable Oil | 2 |
| Sulfur | 0.03 |
| Minors | 3 |
| Water | Quantum satis |

All dry components are weighed, mixed, and ground to the desired particulate size. The mixed and ground dry components are then mixed with the liquid components in a pre-conditioner of a single screw extruder. Steam is then added to the pre-conditioner in accordance with ordinary conditions. The resulting mixture is then extruded through an appropriately set extruder screw. The extrudate is cut to a desired length using rotating knives. The product is then cooled to room temperature and packaged in an air-impermeable container.

### Example 2

The pet food composition is a chew product adapted for use by a domestic dog is prepared using the following components at the approximate indicated amounts:

| | Approximate Amount |
|---|---|
| Component | (by weight of the composition) |
| Wheat Flour and Wheat Gluten | 57 |
| High Fructose Corn Syrup | 13 |
| Glycerin and Glyceryl Monostearate | 13 |
| Beet Pulp | 1 |
| Sodium Tripolyphosphate | 2 |
| Vegetable Oil | 1.5 |
| Minors | 2.5 |
| Sulfur | 0.03 |
| Water | Quantum satis |

The chew product is generally prepared and packaged in accordance with the methods described at Example 1 herein.

### Example 3

The pet food composition is a chew product. All dry components are weighed, mixed, and ground to the desired particulate size. The mixed and ground dry components are then mixed with the liquid components in a pre-conditioner of a single screw extruder. Steam is then added to the pre-conditioner in accordance with ordinary conditions. The resulting mixture is then extruded through an appropriately set extruder screw. The extrudate is cut to a desired length using rotating knives. After cutting the chew, the chew is air dried at ambient conditions (21° C.) for 72 hours. The product is packaged in an air-impermeable container.

The chew product comprises the following:

| Length | Diameter | Water | Max Relaxation | Max Relaxation |
|---|---|---|---|---|
| [mm] | [mm] | Activity | Force [kN] | Stress [MPa] |
| 127 | 32 | 0.57 | 3.1 | 3.7 |

### Example 4

The pet food composition is a chew product. All dry components are weighed, mixed, and ground to the desired particulate size. The mixed and ground dry components are then mixed with the liquid components in a pre-conditioner of a single screw extruder. Steam is then added to the pre-conditioner in accordance with ordinary conditions. The resulting mixture is then extruded through an appropriately set extruder screw. Following extrusion the chew is microwaved in a microwave oven and then cooled in a cooling tunnel. After cooling, the extrudate is cut to a desired length using intermittent knives. The product is packaged in an air-impermeable container.

Following table provides operating conditions for the microwave oven and cooling tunnel:

| Power | Pre Microwave | Pre Microwave | Post Microwave | Post Microwave | Cooler | Cooler |
|---|---|---|---|---|---|---|
| Consumption | Drying Product | Temperature | Drying Product | Temperature | Residence | Temperature |
| [kW] | Moisture [%] | [° C.] | Moisture [%] | [° C.] | Time [min] | [° C.] |
| 13.8 | 17.45 | 82 | 15 | 88 | 20 | 2 |

The chew product comprises the following:

| | | | | Max |
|---|---|---|---|---|
| Length | Diameter | Water | Max Relaxation | Relaxation |
| [mm] | [mm] | Activity | Force [kN] | Stress [MPa] |
| 128 | 19 | 0.57 | 1.52 | 3.15 |

### Example 5

The pet food composition is a chew product adapted for use by a domestic dog is prepared using the following components at the approximate indicated amounts:

| | Approximate Amount |
|---|---|
| Component | (by weight of the composition) |
| Wheat Flour and Wheat Gluten | 57 |
| High Fructose Corn Syrup | 13 |
| Glycerin and Glyceryl Monostearate | 13 |
| Beet Pulp | 1 |
| Sodium Tripolyphosphate | 2 |
| Poultry Fat | 1.5 |
| Minors | 2.5 |
| Sulfur | 0.03 |
| Water | Quantum satis |

The pet food composition is a chew product is generally prepared and packaged in accordance with the methods described at Example I herein.

### Example 6

A pet food composition in the form of a chew product can be adapted for use by a domestic dog can be prepared and packaged in accordance with the methods described in Example 1 herein. A study is conducted to measure the effects of the mechanical cleansing properties of the chew product in a canine feeding model. A general protocol is as follows: Animals are housed at an accredited facility. The study involved a single use, non prophylaxis design to evaluate the mechanical properties. At the start of the test period, all animals were examined for presence of plaque. Following examination, one chew product was given to each animal for consumption. Following consumption, teeth were re-examined for the presence of plaque. For all oral exams, target tooth sites for canine studies include the buccal surfaces on both sides of the mouth at positions: Upper Jaw: 13, C, P2, P3, P4, and M1 and Lower Jaw: C, P2, P3, P4, and M1.

Results are as Follows:

Analysis of Variance^{A} Whole Mouth Average Plaque Score

| | | | | TREATMENT |
|---|---|---|---|---|
| TREATMENT | | ADJUSTED | STARNDARD | COMPARISON |
| PERIOD | N^{b} | MEAN | ERROR^{c} | P-VALUES^{d} |
| Pre-Treatment | 12 | 5.43 | 0.45 | 0.0029 |
| Post-Treatment | 12 | 3.03 | 0.45 | |

^{A}The response in the analysis of variance with the randomized complete block model was the whole mouth average plaque score where dog was the block.
^{b}Number of animals in the indicated treatment group.
^{c}Standard error of the adjusted mean.
^{d}Two-sided p-value to test the null hypothesis that the mean plaque score of two periods are equal.

The data shows that a chew product generally prepared and packaged in accordance with the methods described in Example 1 has the ability to remove oral plaque during mastication and improve oral health status.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and 1 5 modifications can be made without departing from the spirit and scope of the invention. It is therefore intended to cover in the appended claims all such changes and modifications that are within the scope of this invention.

What is claimed is:

1. A pet food composition having a Maximum Relaxation Stress of at least about 2.5 MPa.

2. The pet food composition of claim 1, having a Maximum Relaxation Stress of at least about 2.8 MPa.

3. The pet food composition of claim 1, having a Maximum Relaxation Stress of at least about 3 MPa.

4. The pet food composition of claim 1, which is a supplement.

5. The pet food composition of claim 4, wherein said supplement is a chew.

6. The pet food composition of claim 4, wherein said supplement is a treat.

7. The pet food composition of claim 4, further comprises water.

8. The pet food composition of claim 7, which comprises a humectant that is selected from the group consisting of polyhydric alcohols, sugars and mixtures thereof.

9. The pet food composition of claim 8, wherein at least one humectant is corn syrup.

10. The pet food composition of claim 4, comprising a primary component, by weight of the composition, wherein the primary component is at least one grain source.

11. The pet food composition of claim 10, wherein said grain source is selected from the group consisting of corn, oats, rice, milo, sorghum, barley, wheat, and mixtures thereof.

12. The pet food composition of claim 11, wherein at least one grain source is wheat.

13. A pet food composition having a Maximum Relaxation Force of at least about 1 kN.

14. The pet food composition of claim 13, having a Maximum Relaxation Force of at least about 1.5 kN.

15. The pet food composition of claim 13, having a Maximum Relaxation Force of at least about 2 kN.

16. The pet food composition of claim 13, which is a supplement.

17. The pet food composition of claim 16, wherein said supplement is a chew.

18. The pet food composition of claim 16, wherein said supplement is a treat.

19. The pet food composition of claim 16, further comprises water.

20. The pet food composition of claim 19, further comprises a humectant that is selected from the group consisting of polyhydric alcohols, sugars and mixtures thereof.

21. The pet food composition of claim 20, wherein at least one humectant is corn syrup.

22. The pet food composition of claim 16, comprising a primary component, by weight of the composition, wherein the primary component is at least one grain source.

23. The pet food composition of claim 22, wherein said grain source is selected from the group consisting of corn, oats, rice, milo, sorghum, barley, wheat, and mixtures thereof.

24. The pet food composition of claim 23, wherein at least one grain source is wheat.

25. A process for preparing a pet food composition, wherein said process comprises:
(a) mixing all components;
(b) agitating all components until mixed; and
(c) extruding said pet food composition.

26. The process of claim 25, further comprising:
(d) drying said composition;
wherein said drying is selected from the group consisting of conventional drying, microwave drying, and combinations thereof.

27. The process of claim 25, further comprising:
(e) optionally cooling said composition.

28. A method for improving oral health through reduction of plaque, tartar, stain, and gingivitis comprising; administering to a pet the pet food composition of claim 1.
